(19) United States
(12) Patent Application Publication
(10) Pub. No.: US 2016/0116107 A1
(43) Pub. Date: Apr. 28, 2016

(54) Tarp Weight Device

(71) Applicant: James Brooks, Lewisport, KY (US)

(72) Inventor: James Brooks, Lewisport, KY (US)

(21) Appl. No.: 14/639,561

(22) Filed: Mar. 5, 2015

Related U.S. Application Data
(60) Provisional application No. 62/068,237, filed on Oct. 24, 2014.

(51) Int. Cl. F16M 13/00; B60J 7/10

(52) U.S. Cl. CPC F16M 13/00; B60J 7/104

(57) ABSTRACT

A tarp weight for helping to maintain a tarp in a desired position. The tarp weight includes a cylindrical container defining an interior volume. The upper end of the container includes a fastener, such as a hook, that can be secured to an eyelet of a tarp so as to anchor a portion of the tarp. The lower end of the container includes a removable cap that can be used to seal the interior volume of the container. The removable cap is preferably threaded so that it can be screwed onto and off of the container. The container can be filled with any material such as water, sand, or dirt, among others in order to increase the weight thereof. The lower end of the cap includes a ring thereon for connection to the fastener of a second tarp weight in order to add weight to a portion of the tarp.

### CROSS REFERENCE TO RELATED APPLICATION

This application claims the benefit of U.S. Provisional Application No. 62/068,237 filed on Oct. 24, 2014. The above identified patent application is herein incorporated by reference in its entirety to provide continuity of disclosure.

### BACKGROUND OF THE INVENTION

1. Field of the Invention

The present invention relates to tarp weighting devices. More specifically, the present invention provides a tarp weight having a hollow interior that can be filled with water, sand, dirt, or other materials, and wherein the tarp weight includes a fastener, such as a hook, that can be secured to an eyelet of a tarp in order to anchor a portion of the tarp.

Tarps are often used to cover and protect various objects, equipment, and surfaces from precipitation and other environmental hazards. Tarps may be used to cover a baseball or football field, a lumber pile, equipment stored outdoors such as tractors, and various other objects. However, tarps are lightweight and flexible and are susceptible to being displaced from a desired location due to wind. Thus, during a storm or in other high wind conditions, a tarp can be easily blown off of the item which it is desired to protect.

In order to prevent tarps from being moved out of position due to wind or other environmental conditions, many people place weighted objects on the periphery of the tarp. People may place rocks, bricks, cinder blocks, or other solid, heavy objects on the tarp in order to hold it in position. However, this is inconvenient and can be impractical if the user does not have such items readily available. Thus, a device for weighting a tarp to help hold it in position that is convenient and portable is desired.

2. Description of the Prior Art

Devices have been disclosed in the prior art that relate to tarp weighting devices. These include devices that have been patented and published in patent application publications. These devices generally relate to tarp weighting devices. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 8,327,863 to Dupree discloses weighted charms for umbrellas. The weighted charms including a housing having a decorative shape, such as a star, moon, or sun, among others. The housing includes a pocket for holding a weight therein, and a second pocket for storing an item. The housing further includes an attachment means for securing the housing to an inside bracket of an umbrella. Thus, Dupree relates to weighted umbrella charms and fails to disclose a tarp weighting device.

Another device, U.S. Published Patent Application Number 2006/0150537 to Baum et al. discloses a hold down device for securing a tarp over an object or surface. The device includes a flexible body having a bladder to be filled with liquid or sand. The bladder includes a port opening and a removable cap. The body further includes a plurality of grommets having adjustable clips thereon for securement of the lower end of a tarp. Thus, Baum et al. discloses a device having an elongated flexible body and having a bladder that can be filled with a material. Baum et al. fails to disclose a tarp weight having a rigid construction that includes a removable cap on an end thereof and a fastener on an opposite end.

U.S. Pat. No. 6,966,152 to Glynos discloses a protective tarp comprising a flexible sheet having a plurality of unconnected tank compartments about the periphery thereof. The tanks include a fill orifice with a closure means thereon such that the tanks can be filled with a material in order to weight the tarp. Thus, Glynos discloses a tarp having built-in tanks that can be filled with a material, and does not disclose tarp weights removably securable to the eyelets of a conventional tarp.

U.S. Pat. No. 4,455,790 to Curle discloses a tarp anchoring system comprising a plurality of anchors to be embedded in a pile of grain or similar material. Each anchor includes an attachment element connected to a fastener affixed to the underside of the tarp. Thus, Curle discloses a tarp anchoring system for grain piles that includes anchors and does not include a tarp weight having a cylindrical body that can be filled with sand, liquid, or other materials in order to increase the weight thereof.

Finally, U.S. Pat. No. 5,111,554 to Sweers discloses a hold down strap for holding a tarp. The device includes an elongated body portion having two end portions thereon. The end portions are preferably elastic and include a plurality of eyelet fasteners. Cords or cables can be used to connected the eyelets of one strap with those of another strap or of a tarp or fixed object, in order to hold down a tarp. Thus, Sweers discloses a strap system for holding down a tarp and does not disclose a tarp weighting device having a cylindrical body with an interior volume that can be filled with liquid, sand, dirt or other materials.

These prior art devices have several known drawbacks. Devices in the prior art generally relate to tarp weighting or securing systems. While such devices provide means for securing a tarp in position, some devices disclose tarps having a specific construction, such that chambers on the tarp can be weighted. Thus, such inventions require the user to utilize a specific type of tarp and do not provide means for weighting or anchoring a conventional tarp. The devices in the prior art fail to disclose a tarp weighting device comprising a cylindrical container having a fastener on an upper end thereof, a removable cap on a lower end thereof, and an interior volume to be filled with a material such as sand or dirt for adding weight to the device.

In light of the devices disclosed in the prior art, it is submitted that the present invention substantially diverges in design elements from the prior art and consequently it is clear that there is a need in the art for an improvement to existing tarp weighting devices. In this regard the instant invention substantially fulfills these needs.

### SUMMARY OF THE INVENTION

In view of the foregoing disadvantages inherent in the known types of tarp weights now present in the prior art, the present invention provides a new tarp weight wherein the same can be utilized for providing convenience for the user when securing and maintaining a tarp in a desired position.

It is therefore an object of the present invention to provide a new and improved tarp weight device that has all of the advantages of the prior art and none of the disadvantages.

It is another object of the present invention to provide a tarp weight device having a cylindrical construction and a hollow interior that can be filled with water, sand, dirt, or other materials in order to increase the weight thereof.

Another object of the present invention is to provide a tarp weight device having a fastener, such as a hook, at an upper end thereof for securement to an eyelet on a tarp or to additional tarp weight devices.

Yet another object of the present invention is to provide a tarp weight having a removable cap thereon that provides access to an interior volume of the tarp weight so that the interior volume can be filled with various materials in order to increase the weight of the device.

Another object of the present invention is to provide a tarp weight that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of the tarp weight of the present invention.

FIG. 1B shows a disassembled view of the tarp weight of the present invention.

FIG. 2 shows a perspective view of multiple tarp weights secured together.

FIG. 3 shows a perspective view of a tarp weight as positioned on a tarp.

### DETAILED DESCRIPTION OF THE INVENTION

Reference is made herein to the attached drawings. Like reference numerals are used throughout the drawings to depict like or similar elements of the tarp weight. For the purposes of presenting a brief and clear description of the present invention, the preferred embodiment will be discussed as used for weighting a tarp in order to secure the tarp in a desired position. The figures are intended for representative purposes only and should not be considered to be limiting in any respect.

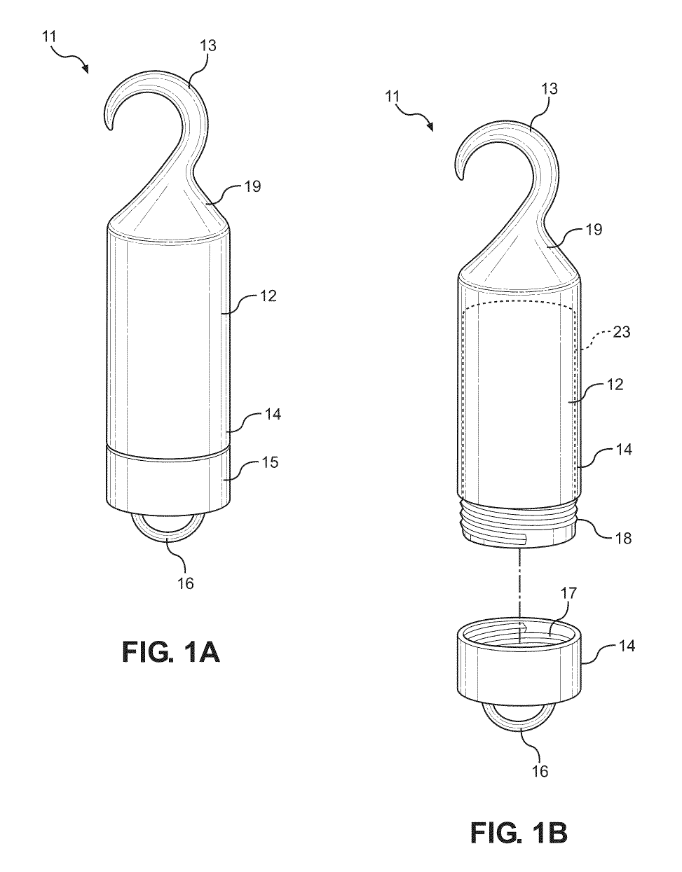

Referring now to FIGS. 1A and 1B, there are shown perspective views of the tarp weight of the present invention as assembled and disassembled, respectively. The tarp weight 11 of the present invention comprises a container 12 having an interior volume 23. The container 12 is preferably cylindrical in shape and includes a closed upper end 19 and an open lower end 14. The container 12 is preferably constructed of a durable, weather resistant material such as a plastic or metal.

The upper end 19 of the container 12 includes a fastener 13 thereon. The fastener 13 preferably includes a hook, but the fastener 13 may alternatively include a carabiner or other similar fastener. The fastener 13 is adapted to be secured to an eyelet of a tarp, or to a ring 16 of another tarp weight 11 of the present invention. The fastener 13 extends upward from the upper end 19 of the container 12. In embodiments wherein the fastener 13 is a hook, the hook can have a rounded point so as to prevent the hook from puncturing a tarp or from causing injury to a user. However, in alternate embodiments, the hook can have a pointed end.

The lower end 14 of the container 12 includes a cap 15 removably secured thereto. The cap 15 includes a ring 16 on a lower end thereof that is adapted to engage with a hook 13 of another tarp weight 11 of the present invention. Preferably, the lower end 14 includes threading 18 on an exterior thereof adapted to engage with the threading 17 on the interior of the cap 15. When the cap 15 is removed, the interior volume 23 of the container 12 of the tarp weight 11 is accessible. With the cap 15 removed, the user can fill the interior volume 23 with any of a variety of materials, including but not limited to dirt, sand, water, pellets, or pebbles. In this way, the tarp weight 11 can be lightweight so that it is easily transported, but can be filled with material to increase the weight thereof in order to help to secure a tarp in a desired position. Once the interior volume 23 is filled, the cap 15 can be secured to the lower end 14 of the container 12. The cap 15 preferably creates a water-tight seal so that any liquid held within the container 12 does not escape therefrom.

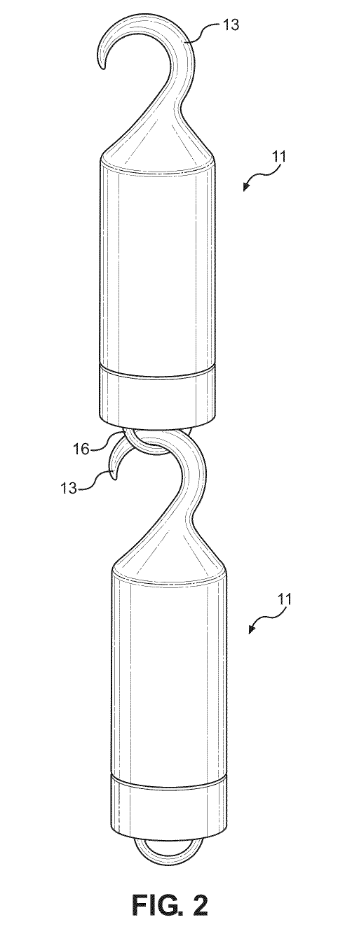

Referring now to FIG. 2, there is shown a perspective view of multiple tarp weights secured together. The upper end of the tarp weight 11 includes a fastener 13 thereon. The fastener 13 can be used to secure the tarp weight 11 to a tarp or the fastener 13 can be secured to a ring 16 on the lower end of the cap of a second tarp weight. In this way, multiple tarp weights 11 of the present invention can be connected in series in order to add weight to a portion of a tarp. This is helpful in situations wherein the weight of a single tarp weight 11 is insufficient to hold a tarp in place, such as during a strong storm or during a period of heavy winds. In this way, multiple tarp weights 11 can be easily connected together as desired, and separated when the tarp weights 11 are no longer needed.

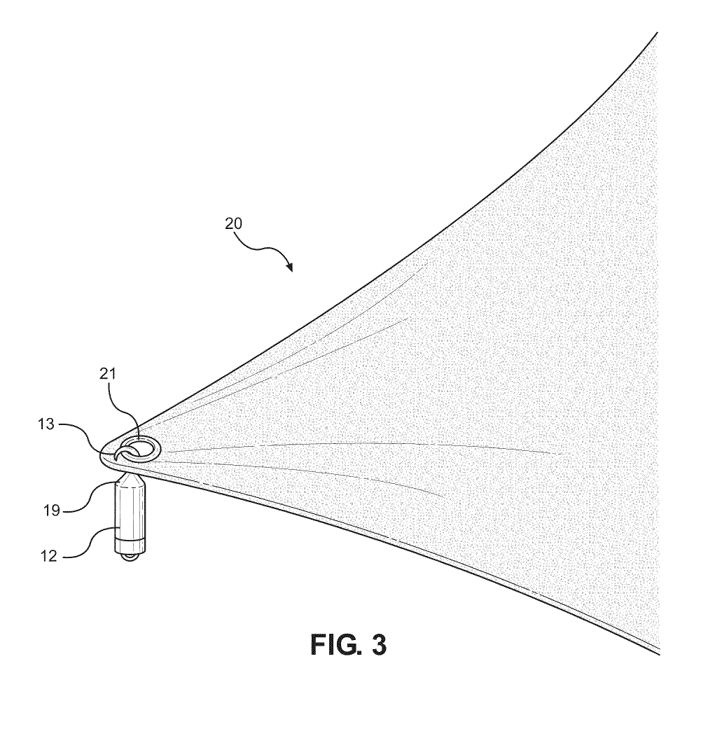

Referring now to FIG. 3, there is shown a perspective view of a tarp weight as positioned on a tarp. The tarp weight 11 can be removably secured to a tarp 20 by engaging the fastener 13 on the upper end 19 of the tarp weight 11 with the eyelet 21 of the tarp 20. The container 12 of the tarp weight 11 hangs downward from the tarp 20 in order to anchor a portion of the tarp 20 and to help maintain the tarp 20 in a desired position. The tarp weight 11 can be easily removed from the tarp 20 by disengaging the fastener 13 with the eyelet 21.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tarp weight, comprising:
a container having a hollow interior volume, a closed upper end, and an open lower end;
a fastener disposed on said upper end;
a cap removably securable to said lower end;
wherein said cap includes a ring thereon.

2) The tarp weight of claim 1, wherein said container is substantially cylindrical.

3) The tarp weight of claim 1, wherein said lower end of said container includes threading thereon adapted to engage with threading on an interior of said cap.

4) The tarp weight of claim 1, wherein said cap is adapted to create a watertight seal with said container.

5) The tarp weight of claim 1, wherein said fastener comprises a hook.

6) The tarp weight of claim 5, wherein said hook extends upward from said container such that said hook is in line with a longitudinal axis of said container.
